(19) United States
(12) Patent Application Publication
(10) Pub. No.: US 2005/0161652 A1
(43) Pub. Date: Jul. 28, 2005

(54) Pivotal lift for vehicle liberation

(76) Inventor: Robert Morgan, Parma, ID (US)

Correspondence Address: PEDERSEN & COMPANY, PLLC, P.O. BOX 2666, BOISE, ID, 83701, US

(21) Appl. No.: 10/946,563

(22) Filed: Sep. 20, 2004

Related U.S. Application Data
(60) Provisional application No. 60/504,269, filed on Sep. 18, 2003.

(51) Int. Cl. B66F 3/00

(52) U.S. Cl. 254/218

(57) ABSTRACT

An easily portable system for extracting vehicles that have become mired in terrain such as mud or sand. A multi-purpose tool(s) is/are provided that may serve as a land-anchor, a fulcrum-lever unit, and a shovel. The land-anchor is placed in the ground and connected to the mired vehicle with a rope, with a come-along or another power source provided. Preferably, a fulcrum-lever is placed in front of the mired vehicle and the rope passes over the fulcrum-lever. so that the fulcrum-lever provides an upward force to the vehicle. When the come-along or other power source draws in the rope, the rope applies both horizontal and vertical force to free the mired vehicle. Alternatively, the system may be used without the fulcrum-lever to free lighter-weight vehicles. Because the land-anchor generally must be placed below ground level and because digging around or under the vehicle often helps to free the vehicle, the multi-purpose unit preferably may be converted into a shovel.

This application claims priority of Provisional Application No. 60/504,269, filed Sep. 18, 2003, entitled “Pivotal Lift For Vehicle Liberation,” which is hereby incorporated by reference.

### BACKGROUND OF THE INVENTION

1. Field of the Invention

This invention relates generally to devices used to extract vehicles from mud or sand, and more particularly to a portable device used to extract a vehicle from mud or sand without the assistance of another vehicle such as a tow truck.

2. Related Art

Getting stuck in deep mud or sand is a recurring problem for drivers of off-road vehicles. The traditional solution has been to attempt to dig out the tires and axle and/or pull the vehicle out with another vehicle, which may instead get stuck itself. This often requires hours of back-breaking effort, even with the help of several people, and digging alone is often not successful. Thus, attempts have been made to provide a way to extract a trapped vehicle.

Chapman (U.S. Pat. No. 4,055,330) discloses a pivotal lift device that consists of a heavy base with an arm that pivots approximately 180° in an arc above the base. The base is positioned in front of the car such that the arm pivots in the direction that the car is facing. The arm is raised to an angle less than 90° relative to the base on the side proximate to the vehicle, but with the end of the arm higher than the trapped vehicle's bumper. A tow-chain is run from a tow truck or other vehicle over a notch on the top of the pivot arm and attached to the vehicle. The vehicle pulls the chain to cause the arm to pivot upward, creating lift as well as forward pull.

Unfortunately, a second vehicle is not always readily available. Furthermore, existing devices, such as Chapman, are large and bulky. Thus, they are not readily transportable, even in vehicles as large as a sports utility vehicle (“SUV”), and less so for smaller cars or all-terrain vehicles (“ATV”). Therefore, there is a need for a portable vehicle extraction system that is not dependent on the availability of tow truck or other second vehicle and is small enough to transport.

### SUMMARY OF THE INVENTION

The present invention is a compact system for extracting a vehicle that has become mired in sand, mud, or other treacherous terrain. A multi-purpose tool may be configured in multiple ways to provide one or more of the following: a lever unit, an anchor unit, or a shovel.

In a preferred method of using two of the invented multi-purpose tools, one tool is configured to be a fulcrum-lever and one is configured to be a land-anchor. Prior to placement of the two tools on/in the ground, one of them is configured as a shovel to dig a hole for the land-anchor. A cable or rope is connected between the vehicle and the land anchor, extending over or through the lever unit, and a come-along, mechanized winch, or other rope-take-up means is provided to cooperate with the anchor and lever units and pull the vehicle from its mired condition.

In other methods of using one or more of the invented multi-purpose tools, the invented extraction system in use with small vehicles need not include a fulcrum-lever, but may be effective with only a land-anchor and come-along or other rope-take-up means. Further, embodiments of the invented system need not always include a land-anchor, for example, wherein the rope is secured to a sufficiently stable object such as a tree or fence post.

While the two units being used as a lever unit and a land anchor need not be identical in order to fulfill their respective roles in the preferred extraction methods, it is preferred that two identical multi-purpose tools are configured differently to serve as a lever unit and a land anchor. Further, it is preferred that both the lever unit and the land anchor unit are configurable as shovels, giving the manufacturer and the user flexibility and convenience by minimizing the pieces of different equipment needed. In the shovel configuration, the tool(s) may be used to bury the land-anchor, dig a footing area for the fulcrum-lever, and/or dig-out the vehicle by removing earth from around the tires or axles, for example.

### BRIEF DESCRIPTION OF THE DRAWINGS

FIG. 1 is a side view of one embodiment of the preferred extraction system attached to a vehicle prior to extraction, wherein two multi-purpose tools are configured to serve as a land anchor and as a lever unit.

FIG. 2 is a side view of the system of FIG. 1, while system is being used to extract the vehicle.

FIG. 3 is a perspective view of the multipurpose unit of FIGS. 1 and 2 in lever unit configuration, with the lever assembly pivotally connected to, and extending from the back of, the head-piece. Thus, configured as a lever unit or “fulcrum-lever,” the unit includes an adjustable/extendable lever assembly with a removable end-piece adapted that holds the rope during extraction of a vehicle but that disengages from the rope and/or from the handle of the unit after extraction of the vehicle.

FIG. 4 is an exploded perspective view of the multipurpose unit of FIGS. 1-3.

FIG. 5 is a perspective view of the multi-purpose unit of FIGS. 1-4 configured as a shovel, with the lever assembly fixed to the back of the head-piece generally parallel to the head-piece, and with the end-piece secured to the handle.

FIG. 6 is a perspective view of the multi-purpose unit of FIGS. 1- 5, configured as a land-anchor or pick, wherein the lever assembly is generally perpendicular to the head-piece, with one end extending through a hole in the head-piece and being non-pivotally fixed to the head-piece. The handle in FIG. 6 is adapted to include a loop at its end, for receiving and capturing the rope in land-anchor mode.

FIG. 7 is a perspective view of an alternative land anchor according to the invention, comprising the unit FIG. 6 without the handle extension and with a loop end connected to the arm end for receiving and capturing the rope.

FIG. 8 is a side view of the preferred come-along of the system of FIGS. 1 and 2.

FIG. 9 is an exploded perspective view of an especially-preferred multipurpose unit, which, as in the embodiments of FIGS. 1-7, the single unit may be easily configured for use as a fulcrum-lever unit, land-anchor unit, or shovel.

FIG. 10 is a front view of the head-piece from the embodiment of FIG. 9, illustrating the hole in the head-piece through which the handle-arm assembly extends for land anchor mode.

FIG. 11 is a top view of another embodiment of the invented multi-purpose tool in storage mode, with the lever assembly generally centered on the head-piece in between the flanges of the head-piece, with a pin securing the lever assembly to the head-piece by extending through the flanges and a bore in the lever assembly that is approximately mid-way along the length of the lever assembly.

### DETAILED DESCRIPTION OF THE INVENTION

Referring to the figures, there is shown several, but not the only, embodiments of the invented multi-purpose or multi-function tool. One embodiment of the present invention is a system that comprises two multi-purpose tool units, a rope, and a come-along, which are used to extract vehicles that are mired in substances such as sand or mud. One of the preferred multipurpose units converts into a land-anchor and the other converts into a fulcrum-lever. The preferred embodiment is powered by a hand-winch, come-along, or other power source that attaches to and pulls the rope. The term “rope” is used in the description to generically to refer to any strap, line, chain, cable, rope or other elongated item used to connect to the mired vehicle.

Referring to FIG. 1, the preferred embodiment of vehicle extraction system 1 is shown ready for use in extracting a mired vehicle. The fulcrum-lever unit 10 is placed in front of the vehicle such that its direction of movement roughly matches the direction the vehicle is facing. A rope 55 is attached to the front of the vehicle and run over the top (preferably the end-piece 14) of fulcrum-lever unit 10, which is preferably inclined toward the vehicle with its end higher than the attachment point. In order to prevent it from moving, the head of the fulcrum-lever unit 10 is preferably placed in a shallow hole, but preferably not buried—this way, the range of motion of the lever assembly 18 is not impeded with dirt or other objects so that it will fall to the ground once the mired vehicle is extracted rather than stick up. However, partial burial of the head-piece 11 may be advantageous to prevent the fulcrum-lever unit 10 from sliding along the ground and/or from falling over to the side. Mainly, it is the downward force applied through rope 55, and friction therefrom, that prevents the fulcrum-lever unit 10 from sliding along the ground, but partial burial of the head-piece 11 may prevent or reduce sliding when fulcrum-lever unit 10 becomes significantly inclined, as occurs during the extraction process.

The other end of rope 55 is attached to come-along 50, which is in turn connected to land-anchor 30, with rope 55 being taut. Land-anchor 30 is placed in a hole such that the ground will prevent it from moving when force is applied along rope 55. Preferably, the hole is dug to be generally T-shaped (viewed from above), with the bottom of the “T” pointing toward the mired vehicle and with the surrounding dirt being left undisturbed. This shape matches the shape of land-anchor 30, and results in the land-anchor being braced against a substantial amount of undisturbed earth, improving its effectiveness. The land-anchor 30 head-piece 11 and a portion of the arm may then be covered with dirt. Come-along 50 is used to draw in rope 55.

Alternatively, other power sources may be used to draw in rope 55. For example, a mechanized winch on the vehicle (not shown) could be used to draw in rope 55 rather than a come-along. Preferably, rope 55 is a flat nylon strap, but could also be any sufficiently strong line, chain, cable, etc.

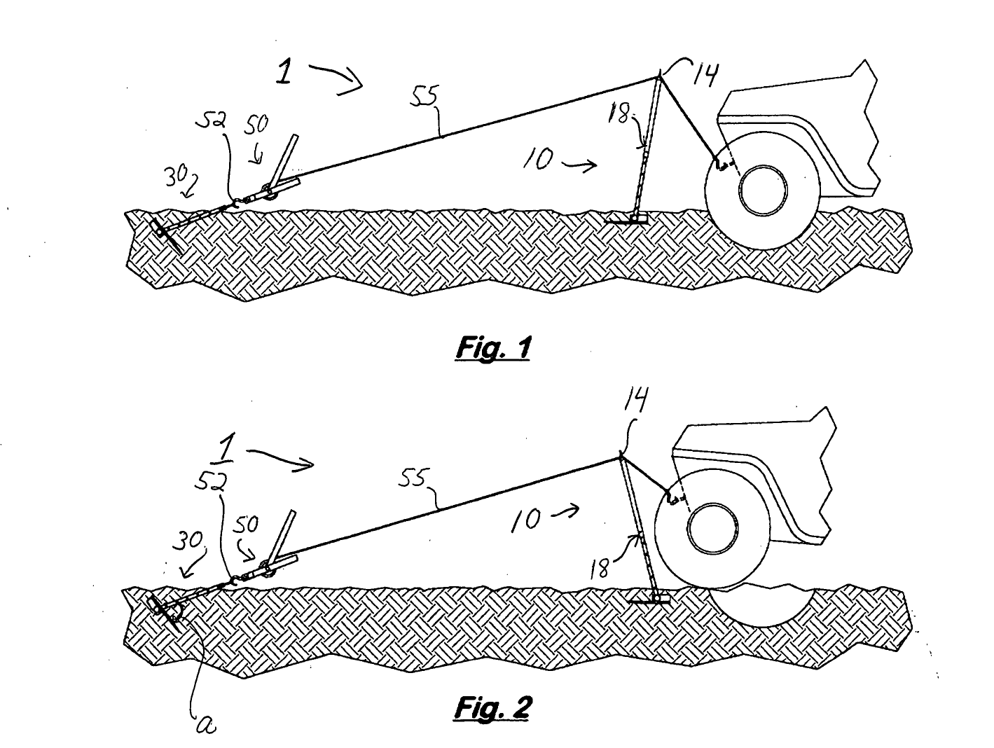

FIG. 2 shows vehicle extraction system 1 after a portion of rope 55 has been drawn into come-along 50. Rope 55 applies force to land-anchor 30 and the vehicle, and, because the land-anchor is firmly and immovably anchored in the ground, the vehicle is pulled forward. The fulcrum-lever unit 10 has the effect of converting part of the horizontal force on rope 55 into vertical force, lifting the front of the vehicle as well as pulling it forward. As rope 55 is pulled in, preferably the rope does not slide in the end-piece but instead pulls on the lever assembly 18. The lever assembly 18 pivots toward land-anchor 30, creating lifting force as lever assembly 18 pivots upward to a completely upright position. As lever assembly 18 tips toward land-anchor 30, it will eventually reach a point where it will disengage from rope 55, by virtue of the end-piece 14 disengaging from the lever assembly 18 and/or by the rope disengaging from the lever assembly 18 (in embodiments in which there is no rope retainer on the end-piece). With the lever assembly thus disengaged from the rope 55, the lever assembly 18 is free to fall (pivot) to the ground.

Fulcrum-lever unit 10 converts part of the horizontal force applied to rope 55 by come-along 50 into vertical force. First, the fulcrum-lever unit's highest point is above the attachment of the rope to the vehicle, so that the angle of the rope between the fulcrum-lever 10 and the vehicle has a vertical component. Further, when fulcrum-lever unit 10 is initially set up inclined toward the mired vehicle, its movement as it pivots toward come-along 50 raises its highest point. This creates vertical (lifting) force on the front of the mired vehicle. If there were not fulcrum-lever unit 10, the vehicle would be pulled forward only and the system would have to overcome the resistance to forward movement created by the earth obstructing the vehicle—e.g. the earth surrounding the lower portion of a wheel(s) or on which a vehicle has become high-centered. Thus, fulcrum-lever unit 10 significantly reduces the rope tension required to free the vehicle, and, with it, the force applied to land-anchor 30, by reducing the resistance to moving the vehicle. A fulcrum-lever unit 10 is highly preferred for embodiments used to extract a large vehicle-e.g., an SUV. However, there is no need for this tension-reducing function if the mired vehicle is not heavy—e.g., an ATV—and, consequently, fulcrum-lever unit 10 is not required in all embodiments of the invented system.

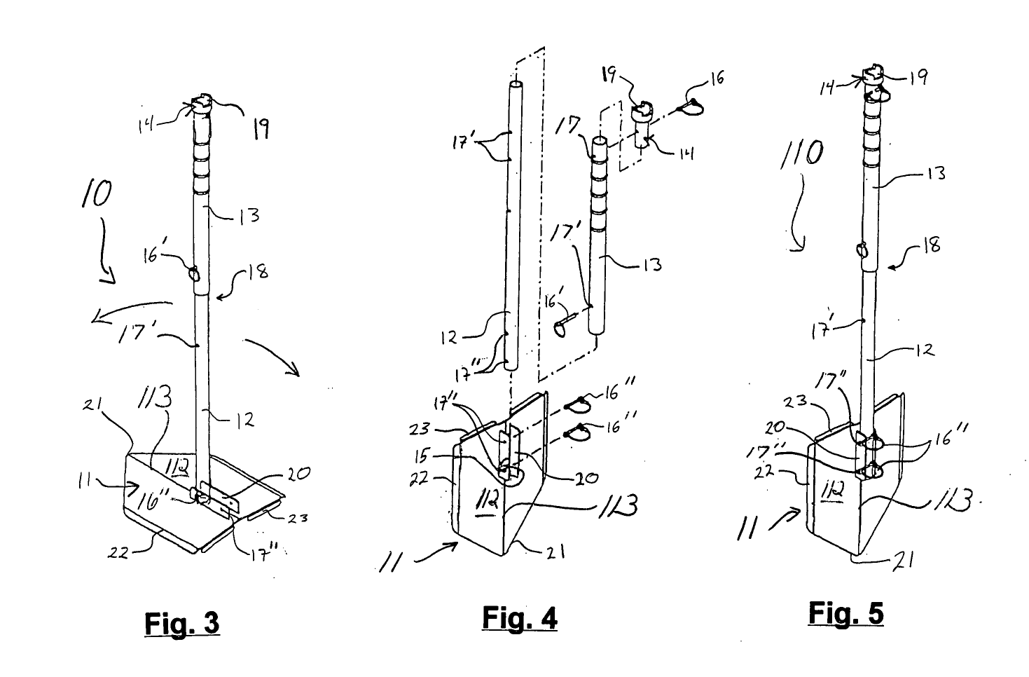

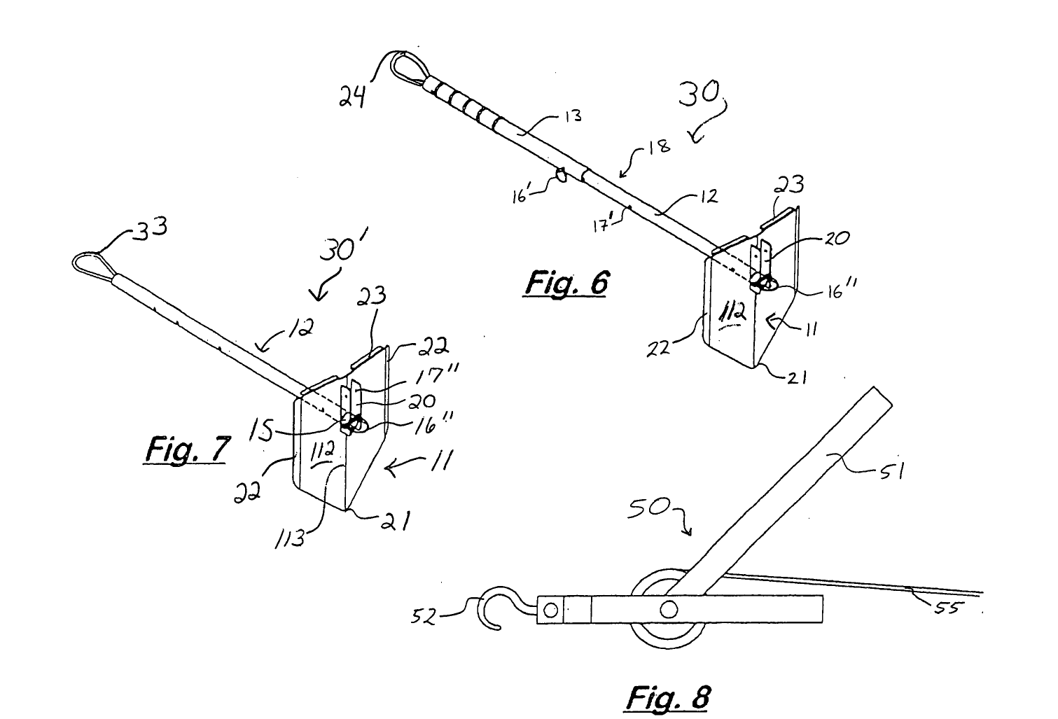

FIGS. 3-5 show the preferred multipurpose unit, which may be used in a plurality of locations for various functions, as a fulcrum-lever unit 10 (FIG. 3), as shovel 110 (FIG. 5), or a land anchor 30 (FIGS. 6 and 7). Referring to the exploded view in FIG. 4, the preferred multi-purpose unit comprises a head-piece 11, arm 12, handle 13, and end-piece 14. Pin 16 may be used to attach the end-piece to the handle. Pin 16′ may be used to connect the handle to the arm and to adjust the length of the resulting lever assembly (arm 12, handle 13, and end-piece 14, collectively). Pin 16″ may be used to connect the arm to the head-piece either in pivot fashion (fulcrum-lever) or in fixed fashion (land anchor or shovel). Corresponding pin-holes are supplied: pin-holes 17 in the distal end of the handle, pin-holes 17′ in the proximal end of the handle and the distal end of the arm, and pin-holes 17″ in the proximal end of the arm and the flanges 20 of the head-piece. Multiple sets of pin-holes 17′ are provided in arm 12 for connecting with handle 13, allowing the user to adjust the length of the lever assembly 18. The preferred pin 16, 16′, 16″ is a wire safety pin, which has a loop that is attached to one end of pin and catches on the other end. This one-piece pin is preferred because there are fewer small parts that may be lost. However, other pins that are held in place with other means, such as nuts or Cotter keys, may be substituted. Also, although arm 12, handle 13, and end-piece 14 are shown as three separate pieces to allow more compact storage, they may be combined into one or two pieces without exceeding the scope of the invention.

The end-piece that is adapted to receive and support the rope 55 during extraction of the vehicle may also be adapted to release the rope 55, preferably by the end-piece falling away from the rope 55, after extraction of the vehicle. Alternatively or additionally, the end-piece may stay with the rope but disengage from the handle-arm system. This way, the rope does not stay with the fulcrum-lever unit 10 after the vehicle is liberated, and the vehicle can be pulled further, even over and forward relative to, the fulcrum-lever unit 10. This way, continuing to pull the rope does not drag the unit 10 along with the vehicle.

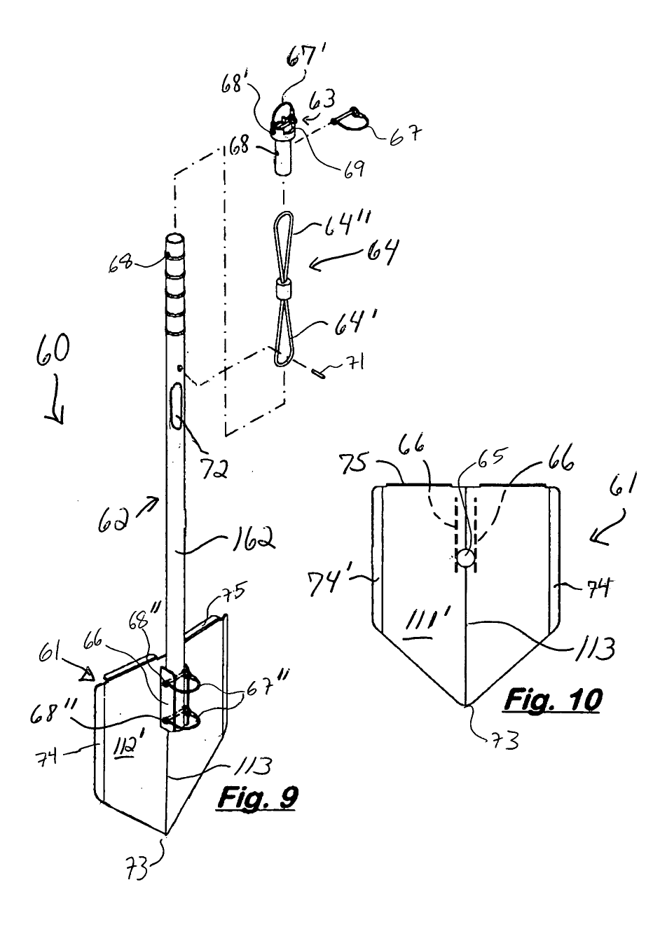

The preferred end-piece 14 is a separate piece that removably fits into the open end of handle 13, and that removably receives the strap in its distal channel (“notch” 19). Preferably, the rope disengages from the end-piece 14 when lever assembly 18 falls to the earth once it has pivoted far enough toward land-anchor 30 (FIGS. 1 and 2). In other words, notch 19 may be left open so as to allow lever assembly 18 to separate from rope 55. In such cases, the end-piece 14 may be held in the handle by an end-piece retainer (see pin 16 in FIG. 3 and pin 67 in FIG. 9). Optionally, a pin (see 67′ in FIG. 9) or other rope retainer may be used to hold the rope in the notch 19 of the end-piece, in which case it is preferred that the end-piece is not fixed to the lever assembly 18, so that end-piece 14 will separate from the lever assembly when the lever assembly pivots down to the ground. Optionally, the lever system 18 may be used without any rope retainer and without any end-piece retainer, so that the rope is free to leave the notch 19 and the end-piece 14 is free to slide out of the handle, when the lever assembly falls down and the end-piece 14. With any of these options, once the vehicle is freed, the lever assembly 18 is typically pointing forward, on the ground, and detached from the rope, so that the rope may continue to be taken-in without pulling the fulcrum-lever unit 10. After extraction of the vehicle, it is preferred that rope 55 disconnects from the fulcrum-lever unit, and this is accomplished in the preferred embodiments by end-piece 14 not being fixedly connected to handle 13. After extraction of the vehicle by means of rope 55 pivoting the handle/arm of the fulcrum-lever away from the vehicle, the handle/arm continues to pivot to a position wherein rope 55 pulls the end-piece 14 out of the handle, and the handle/arm pivots to the ground. In other words, adaptation of the end-piece to be slidably or otherwise removable from the handle/arm facilitates the separation of end-piece 14 from handle 13 at the end of the extraction process, as described more fully below. This way, the vehicle may be pulled to and across the fulcrum-lever unit 10 without damage to either the vehicle or the fulcrum-lever unit 10.

Alternatively, end-piece 14 could be permanently fixed to, or made an integral part of, the lever assembly 18. If so, a rope retainer would preferably not be used, as discussed above.

When the multipurpose unit is assembled as a fulcrum-lever unit 10, as shown in FIG. 3, arm 12 is attached to flanges 20 on head-piece 11 by only one pin 16″, allowing it to pivot relative to head-piece 11. In this configuration, the arm and handle extend up from the back of the head-piece 11 and the concave front surface of the head-piece 11 faces downward. End-piece 14 includes a notch 19 through which rope 55 passes during use, as shown in FIGS. 1 and 2. As discussed above, a pin-strap or other rope retainer (not shown in FIG. 3) may be placed over the top of notch 19 after rope 55 in put in place, to prevent rope 55 from slipping off end-piece 14 during set-up and use.

Referring to FIG. 5, the multi-purpose unit of FIG. 3 is shown assembled for use as a shovel 110. There are two flanges 20 on the back of head-piece 11. One edge 21 of head-piece 11 is generally pointed and functions as the point of the shovel when so configured. Flanges 20 are parallel and spaced apart by a distance at least slightly greater than the diameter of arm 12, which fits between them, and are roughly centered on head-piece 11. Arm 12 is attached to head-piece 11 between flanges 20 at two points with pins 16. Pins 16″ pass through pin holes 17″ in flanges 20. Although end-piece 14 is shown in FIG. 5 as being attached to the end of handle 13, it is unnecessary when fulcrum-lever 10 is being used as a shovel. Top flanges 23 facilitate use as a shovel by providing a convenient place for the user to push on head-piece 11 while shoveling.

Preferably, the lever assembly 18 is capable of pivoting 180° relative to its head-piece 11, so that it will fall to the ground once the mired vehicle is extracted.

The preferred multipurpose unit may also be adapted to be a land-anchor 30, as illustrated in FIG. 6. Arm 12 passes through hole 15 in head-piece 11 and is secured to head-piece 11, for example, with a single pin 16″ through the proximal end of the arm and the flanges 20. This way, the arm is retained from being pulled out of the head-piece by means of the pin 16″ and is retained from pivoting relative to the head-piece 11 by means of the arm being retained at two spaced locations, that is, at the head-piece around the hole 15 and at the pin 16″. Handle 13 is attached to arm 12 with a pin 16′. End-piece 14 is removed and loop 24, which is preferably slidably connected to handle 13 is slid out from inside handle 62. Numerous other means exist for connecting loop 24 to the handle, and numerous other means besides loop 24 exist for connecting handle 13 to come-along 50, but loop 24 is preferred because it does not need to be removed (rather is pushed into the handle) when end-piece 14 is put in place. For example, a handle or other loop could be connected to the end of handle 13 with a pin 16, but that is less preferred because additional pieces would make the system bulkier when stored and are more likely to be lost.

Side flanges 22 and top flanges 23 help to keep the land-anchor immobile by catching in the dirt and resisting movement. Preferably, edge 21 is pointed downward when the land-anchor is placed in the ground as it is better able to penetrate loose soil at the bottom of the hole, making the land-anchor more firmly entrenched.

FIG. 7 shows an alternative configuration of the multi-purpose unit for use as a land-anchor 30′. Arm 12 is attached to head-piece 11 between flanges 20, as described above for FIG. 6, by means of pin 16″ passing through pin holes 17″ in flanges 20. In this embodiment, the handle 13 is removed/not included, and the shorter arm 12 is adapted to include loop 33 at its end for attachment to the rope 55 or to come-along 50 during use of the system. As in the embodiment in FIG. 6, the arm 12 is attached to the head-piece “generally perpendicularly” and does not pivot or move significantly relative to the head-piece. By “generally perpendicularly,” it is meant that the angle α between handle 32 and head-piece 11 (shown in FIG. 2) is between about between 30° and 90°, inclusive. Preferably angle α is 90° or less, and most preferably, angle α is about 70°. If angle α is allowed to be greater than 90°, land-anchor 30 has a tendency to slide upward and out of the ground during use. Conversely, when angle α is less than 90°, applying force to rope 55 tends to cause land-anchor 30, 30′ to burrow deeper into the ground, making it more reliable and effective. This angle is a function of the relative position of hole 15 versus pin holes 17″ in flanges 20.

Hole 15 is preferably placed in approximately the center of head-piece 11. This results in an even distribution of force over the face of the land-anchor. If hole 34 is significantly off-center, torque is created by the force of rope 55, which could bend head-piece 11 or handle 32, destroying the device and/or causing it to fail. Edge 21 of head-piece 11 is somewhat pointed for use as a shovel. Side flanges 39 and top flanges 40 help to keep the land-anchor immobile by catching in the dirt and resisting movement. Preferably, edge 21 is pointed downward when the land-anchor is placed in the ground as it is better able to penetrate loose soil at the bottom of the hole, making the land-anchor more firmly entrenched.

Head-piece 11 is preferably not flat, but is rather curved or bent to provide a generally front concave surface 111 (see FIG. 9) and an opposite, rear convex surface 112, to improve its capacity as a shovel and as a land-anchor. The concave and convex surfaces 111, 112, are formed in the preferred embodiments by bend 113 in the plate of the head-piece.

FIG. 8 depicts the preferred come-along 50 that is used to extract a vehicle. It attaches to rope 55 and uses cam lever 51 to apply force to the ATV by pulling in rope 55. It also attaches to land-anchor 30, 30′ via hook 52. If the ATV being extracted has a mechanized winch, rope 55 may be attached thereto. In that scenario, the winch may be used to apply the necessary force, and come-along 50 is unnecessary, but may still be desired to connect rope 55 to land-anchor 30, 30′.

FIG. 9 depicts the most preferred embodiment of the multipurpose tool 60. As in the previous embodiments, this device combines the elements and function of a fulcrum-lever and a land-anchor into a single multipurpose tool 60. Like the embodiments in FIGS. 3-7, the multipurpose tool 60 includes a lever assembly 62. Lever assembly 62 comprises a single elongated member 162, and end-piece 63 which may be fixed to member 162 by pin 67 through pin-holes 68. A rope retainer pin 67′ may be inserted through pin-holes 68′ to hold the rope in the notch 69 of end-piece 63. Head-piece 61 has a hole 65 in its approximate center, and on the back of the head-piece are two flanges 66 are placed parallel to each other about the same distance from hole 65. Two sets of pin-holes 68″ are placed in flanges 66 and corresponding (similarly spaced) pin-holes 68″ are placed in the lever assembly 62, for receiving pins 67″. In similar manner to the configurations and uses represented in FIGS. 3-7, the lever assembly may be fixed to the head-piece generally parallel to the plane of the head-piece (as in FIG. 9) for use as a shovel, or may be pivotally connected to the head-piece (for example, by one pin) extending out from the back (112) of the head-piece, for use as a fulcrum-lever unit. Or, the proximal end of the elongated member 162 may be pushed through the hole 65 and fixed to the flanges 66, so that the lever assembly extends generally perpendicularly out from front (111) of the head-piece, for use as a land-anchor.

Lever assembly elongated member 162 is preferably cylindrical in shape and is sized to fit between flanges 66. At the opposite end of member 162, preferred wire loop 64 is placed inside member 62, and adapted so that it may be either pushed entirely inside member 62 for storage when the unit 60 is used as a fulcrum-lever or shovel, or partially extracted therefrom so that it may be attached to rope 55 or come-along 50 when the unit is used as a land anchor. A hole 72 is provided in the side of member 162 to allow the user to reach wire loop 64 and push it out the end of member 162. A pin 71 is welded or otherwise attached inside member 162, across the diameter of the member 162 and extending through the lower loop 64′ of wire loop 64 when the loop 64 is inside the member 162. This way, the loop 64 may be slid out to an extent that allows upper loop 64″ to protrude from the member 162, but so that the loop 64 is prevented from coming completely out of member 162. Numerous other means for connecting the lever assembly 62 to come-along 50 exist, but loop 64 is preferred because it does not need to be removed when end-piece 63 is put in place. For example, a handle, loop, hook or other member for connecting to the come-along 50 could be attached or integral with the end of lever assembly 62, but such additional pieces might interfere with the end-piece 63, make the system bulkier when stored, and/or more likely be lost.

As described above, it is preferable that end-piece 63 be a separate piece from member 162, and that end-piece 63 be capable of easily coming off member 162 at the appropriate time, once the mired vehicle is completely or nearly extracted. Alternatively, end-piece 63 could be integral with handle 62 or securely fixed for example by pin 67.

Edge 73 of head-piece 61 is somewhat pointed for use as a shovel. Top flanges 75 facilitate use as a shovel by providing a convenient place for the user to push on head-piece 61 while shoveling. Side flanges 74 and top flanges 75 help to keep the land-anchor immobile by catching in the dirt and resisting movement. Preferably, edge 73 is pointed downward when the land-anchor is placed in the ground as it is better able to penetrate loose soil at the bottom of the hole, making the land-anchor more firmly entrenched.

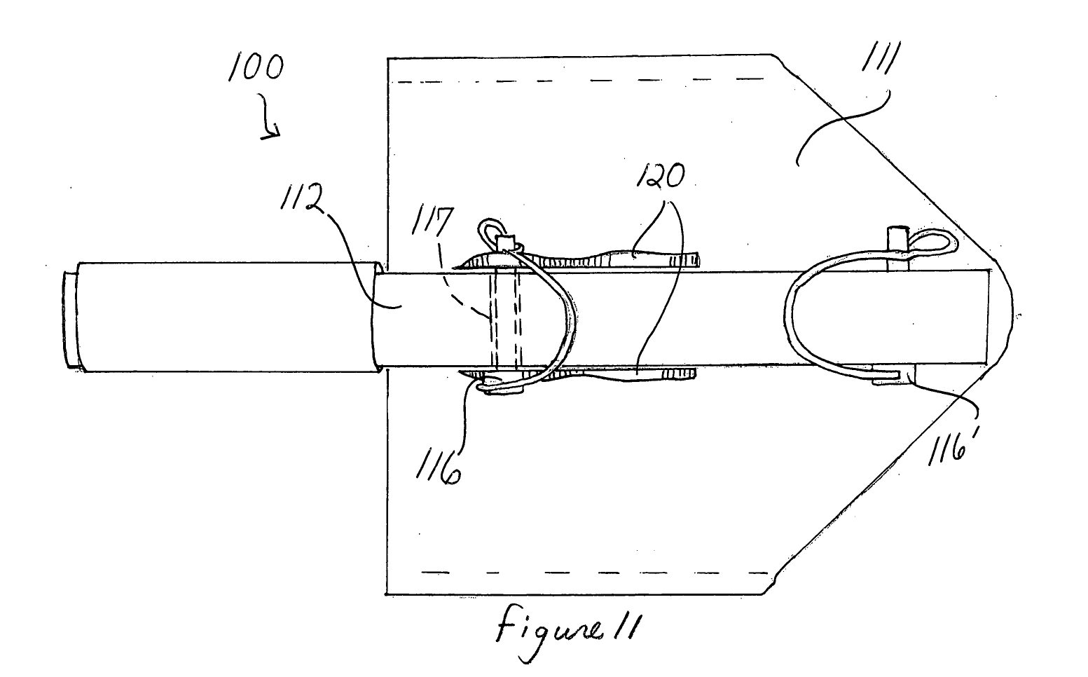

FIG. 10 is a front view of head-piece 61, illustrating the concave front surface 111′ and the through-hole (hole 65) that is generally centered longitudinally and transversely (top to bottom, and side to side, respectively, in FIG. 10). By generally centered, it is meant that the hole is located from ⅓ to ⅔ of the way down the head-piece from the top edge (75) of the head-piece to the pointed edge 73, and is located from 1/3 to 2/3 of the way from one side edge (74) to the other (74′).

Returning to FIGS. 1 and 2, two of multipurpose tool 60 may be used both for fulcrum-lever unit 10 and land-anchor 30. First, a hole is dug several feet in front of the mired vehicle. Multipurpose tool 60 may be configured as a shovel and used to accomplish this digging task. Then, first multipurpose tool 60 is then assembled as a land-anchor and placed in the hole. It may then be buried, if necessary to immobilize the land-anchor. First multipurpose tool 60 is attached to come-along 50 via the outer end 64″ of loop 64 and hook 52. A second multipurpose tool 60 is assembled as a fulcrum-lever unit and placed just in front of the mired vehicle, preferably in a shallow hole/depression in the ground. Rope 55 is run from come-along 50 over end-piece 63, through notch 69, and connected to the mired vehicle. A pin 67 is preferably attached to end-piece 63 so that rope 55 passes under it. Also, end-piece 63 is preferably not fixedly connected to lever assembly 62. Any slack in rope 55 is removed with come-along 50. Preferably, lever assembly 62 is inclined slightly toward the mired vehicle. Now that the system is positioned and configured for use, come-along 50 is operated to draw in rope 55. This applies lateral force to the mired vehicle, and a portion of the force is converted to vertical force by virtue of the lever assembly 62 raising the rope and by virtue of the pivoting movement of lever assembly 62. Continued use of come-along 50 lifts and pulls the vehicle from the holes in which its tires have become mired or from a high-centered condition. As rope 55 is drawn into come-along 50, lever assembly 62 tilts toward first land anchor multipurpose tool until it reaches a point where end-piece 63 will disengage from member 162. Member 162 will then fall to the ground allowing the vehicle to be pulled or driven over it without contacting it or being connected to it in any way. This is preferred in order to avoid damage to the vehicle.

Preferred embodiments of the invented multi-purpose tool may be stored compactly and conveniently. As illustrated in FIGS. 11, a multi-purpose tool 100 may be stored by placing the lever arm 112 in between the flanges 120 and securing the arm 112 by placing a pin 116 through the flanges and a bore 117 approximately midway along the length of the arm. This way, the surface of the head piece/plate 111 supports the arm 112 on both sides of the pin 116, so the arm 112 will not be likely to pivot relative to the head piece 111. Also, this way, the arm is generally centered on the head piece 111 and the stored tool is compact. Additional pin 116′ is stored by inserting it through one of the holes in the proximal end of the arm 112.

Although this invention has been described above with reference to particular means, materials, and embodiments, it is to be understood that the invention is not limited to these disclosed particulars, but extends instead to all equivalents within the scope of the following claims.

1. A multi-purpose tool comprising:
a head comprising a head plate and a plurality of attachments on said head plate;
a lever arm that is removably attachable to each of said plurality of attachments;
wherein, when said lever arm is attached to a first attachment of said plurality, the lever arm pivots relative to the head plate for use as a fulcrum-lever;
wherein, when said lever arm is attached to a second attachment of said plurality, the lever arm is fixed position relative to the head plate and generally parallel to the head plate for use as a shovel; and
wherein, when said lever arm is attached to a third attachment of said plurality, the lever arm is fixed position relative to the head plate and generally perpendicular to the head plate for use as a land anchor.

2. The tool of claim 1, wherein, when the lever arm is attached to said first attachment, the lever arm pivots at least 180 degrees in a plane perpendicular to the head plate.

3. The tool of claim 1, wherein said third attachment comprises a hole through the head plate, and wherein, when the lever arm is attached to said third attachment, the lever arm extends through said hole.

4. The tool of claim 1, wherein the head plate has a perimeter edge with a side that forms a point, for use as a shovel blade.

5. The tool of claim 1, wherein:
said plurality of attachments comprise parallel flanges extending generally perpendicularly from the head plate and having a plurality of sets of holes along the length of the flanges;
the lever arm has a longitudinal axis and a proximal end with a bore extending through the lever arm transversely to the longitudinal axis; and
when said lever arm is attached to the first attachment, the tool comprises a pin extending through one of said set of holes in the flanges and through the bore of the lever arm to pivotally secure the lever arm between the flanges.

6. The tool of claim 1, wherein:
said plurality of attachments comprise parallel flanges extending generally perpendicularly from the head plate and having a plurality of sets of holes along the length of the flanges;
the lever arm has a longitudinal axis and a plurality of bores extending through a proximal end of the lever arm transversely to the longitudinal axis; and
when said lever arm is attached to the second attachment, the tool comprises two pins extending through different sets of said sets of bores in the lever arm and through different of said holes in the flanges to secure the lever arm non-pivotally between the flanges and generally parallel to the head plate.

7. The tool of claim 6, wherein said lever arm has a middle bore generally midway along its length, and wherein said lever arm is adapted to be secured between said flanges with a pin extending through one of said sets of holes in the flanges and through the lever arm middle bore.

8. The tool of claim 1, wherein the head plate comprises a bottom edge with a shovel point and an opposing top edge with top flanges extending perpendicularly to the plane of the head plate, wherein the top flanges are adapted for a user to push on when the tool is used as a shovel.

9. The tool of claim 1, wherein the lever arm has a longitudinal axis and a distal end with a notch extending transversely to the longitudinal axis for removeably receiving a cable.

10. The tool of claim 1, wherein the lever arm has a longitudinal axis, a distal end, and an end member slideably and removeably received on the distal end, the end member having a notch extending transversely to the longitudinal axis for removeably receiving a cable.

11. A multi-purpose tool adapted for use in extracting a vehicle from being mired in material such as mud or sand, the tool comprising a head piece and a lever arm that are adapted to removeably connect to each other in a plurality of different configurations, said configurations comprising:
a first lever configuration wherein the lever arm is pivotally connected to a back surface of the head piece so that the head piece pivots perpendicularly to the head piece for use in leveraging a vehicle out of a mired condition;
a second shovel configuration wherein the lever arm is non-pivotally secured to the back surface of the head piece for use as a shovel;
a third land anchor configuration wherein the lever arm extends non-pivotally generally perpendicularly from the head piece for use as a land anchor.

12. The multi-purpose tool of claim I 1 comprising two flanges on the back surface of the head piece, wherein, in said first configuration, the lever arm has a proximal end received between the two flanges and pivotally connected to said two flanges by a pin extending through the flanges and the lever arm.

13. The multi-purpose tool of claim 11 comprising two flanges on the back surface of the head piece, wherein, in said second configuration, the lever arm has a proximal end received between the two flanges and connected to said two flanges at two locations along the length of the proximal end so that the lever arm is non-pivotal relative to the flanges.

14. The multi-purpose tool of claim 11, wherein, in the third configuration, the lever arm slideably extends through a hole in the head piece to lie on both a front side and a rear side of the head piece.

15. The multi-purpose tool of claim 14, further comprising a removable fastener connecting the lever arm to the head piece on one of either said front side or rear side.

16. The tool of claim 11, wherein, in the first lever configuration, the lever arm is pivotal at least 180 degrees in a plane perpendicular to the head piece.

17. A system for extracting a vehicle mired in mud or sand, the system comprising:
a lever tool comprising a first plate member for placement in front of a mired vehicle, and a lever arm pivotally attached to the first plate member and having a distal end receiving a cable that is attached at one end to the vehicle, wherein the lever arm is generally upright in front of the vehicle;
a land anchor tool spaced from said lever tool and comprising a second plate member and an anchor arm extending generally perpendicular to the second plate member, said second plate member for being at least partially buried in the ground, and the anchor arm extending toward said lever tool and having a distal end receiving the cable;
wherein, when the cable is pulled toward the land anchor tool, the lever arm of the lever tool pivots away from the vehicle and lifts the cable and vehicle up and toward the land anchor tool, and
when the lever arm pivots away from the vehicle, said distal end of the lever arm is adapted to release the cable from the lever arm.

18. A system as in claim 17, wherein said distal end of the lever arm is adapted to release the cable from the lever arm via a notch in the distal end that receives the cable when the lever arm is generally upright but that releases the cable when the lever arm pivots away from the vehicle to being generally horizontal.

19. A system as in claim 17, wherein said distal end of the lever arm is adapted to release the cable from the lever arm via the distal end comprising an end-piece that slides off of the lever arm when the lever arm pivots away from the vehicle to be generally horizontal.
